(19) United States
(12) Patent Application Publication
(10) Pub. No.: US 2010/0078293 A1
(43) Pub. Date: Apr. 1, 2010

(54) Conveyance Control Device, Control Method Of Conveyance Device, And Observation Device

(75) Inventors: Yoshitaro YAMANAKA, Osaka (JP); Mikio HOUJOU, Osaka (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Osaka (JP)

(21) Appl. No.: 12/568,058

(22) Filed: Sep. 28, 2009

(30) Foreign Application Priority Data
Sep. 29, 2008 (JP) 2008250192

(51) Int. Cl. B65G 43/00

(52) U.S. Cl. 198/464.1

(57) ABSTRACT

A conveyance control device includes a drive mechanism to drive a reciprocating body, an origin sensor, a drive amount detection unit for detecting the drive amount of the drive mechanism, and a movement detection unit for optically detecting the reciprocating body's shifting from a resting state to a moving state. After the reciprocating body is moved in one direction until the origin sensor turns from a first output state to a second output state, the reciprocating body is moved in the opposite direction until the origin sensor turns back to the first output state. A first drive amount from when the origin sensor turns to the second output state to when the reciprocating body shifts from the resting state to the moving state, and a second drive amount from when the reciprocating body shifts to the moving state to when the origin sensor turns to the first output state are acquired.

### CROSS REFERENCE TO RELATED APPLICATIONS

This application claims priority based on 35 USC 119 from prior Japanese Patent Application No. P2008-250192 filed on Sep. 29, 2008, the entire contents of which are incorporated herein by reference.

### BACKGROUND OF THE INVENTION

1. Field of the Invention

The present invention relates to a conveyance device for holding and reciprocating a conveyance object on a predetermined conveyance path. The present invention also relates to a control method of the conveyance device and an observation device provided with the conveyance device.

2. Description of Related Art

Generally, a conveyance device for reciprocating a conveyance object along a predetermined conveyance path includes a reciprocating body for holding and reciprocating the conveyance object on the predetermined conveyance path and a drive mechanism for driving the reciprocating body along the conveyance path. In such a conveyance device, in order to return the reciprocating body to an origin position on the conveyance path, an origin sensor is provided which is switched from an OFF state to an ON state by the reciprocating body when the reciprocating body has reached the origin position.

A gear mechanism and a pulley mechanism for example are adopted as the drive mechanism, which converts the rotation of a motor as a power source to reciprocating motion and transmits it to the reciprocating body. The amount of motor operation can be measured by counting the number of drive pulses using for example an internal counter of a motor controller. In addition, an inductive proximity sensor can be used as the origin sensor, wherein a detection coil generating a magnetic field detects changes in impedance caused by an object moving in the magnetic field object.

In a drive mechanism in which a gear mechanism is used, a backlash can exist between gears, and therefore, when a conveyance object is moved in one direction along the conveyance path and thereafter moved backward in the opposite direction, a period occurs during which the motor runs idle due to the backlash and during which the conveyance object remains stopped even if the motor is rotating.

Thus, Japanese Patent Laid-Open No. 2005-092152 describes technology wherein lost motion caused by the backlash is prevented by unifying the drive direction in one direction when the drive mechanism is stopped.

Japanese Patent Laid-Open No. 2004-283977 describes technology wherein in a slitter device for slitting while conveying a sheet-like material printed in a number of colors, printing deviations of two reference marks printed on the sheet-like material are inspected by detecting a distance between the two reference marks.

However, in the conventional technology that unifies the drive direction in one direction when the drive mechanism is stopped, while the lost motion caused by the backlash does not occur when the drive mechanism is driven in one direction, if the drive mechanism is driven in the opposite direction, lost motion caused by the backlash occurs and positioning control conducted by the drive mechanism contains error because a measurement of such backlashes cannot be detected quantitatively.

On the other hand, in the conventional technology wherein two reference marks are printed on a sheet-like material, as a conveyance object is moved and the distance between the two reference marks is detected, and while it is possible to inspect the printing deviations of the reference marks and to correct the position of the sheet-like material according to the amount of deviations, the conventional technology cannot address, for example, a position detection error in a current usage environment wherein the origin sensor determines a reference position of the motor operation and change over time with an amount of the backlash contained in the drive mechanism.

In operation of the origin sensor, a position detection error can exist due to a difference in responsiveness between switching from the ON state to the OFF state upon the approaching of a detection object and switching from the OFF state to the ON state with the leaving of the detection object. Therefore, a gap exists between a position at which switching from the ON state to the OFF state is detected and a position at which switching from the OFF state to the ON state is detected.

While the backlash changes over time, the position detection error of the origin sensor changes with an influence by a current usage environment, e.g. the temperature. Therefore, a correction of the drive amount taking into consideration the feed amount error (backlash) specific to the drive mechanism and a correction of the drive amount taking into consideration the position detection error specific to the origin sensor need to be performed individually. However, in the conventional technology, the measurement of the feed amount error specific to the drive mechanism and the measurement of the position detection error specific to the origin sensor cannot be known individually.

Therefore, an object of the invention is to provide a conveyance control device, a control method of the conveyance device, and an observation device, which can individually acquire the feed amount error of the drive mechanism and the position detection error of the origin sensor, and can perform a control operation by individually taking into consideration the feed amount error and the position detection error in a positioning control of the reciprocating body.

### SUMMARY OF THE INVENTION

One aspect of the present invention relates to a conveyance control device, which includes a reciprocating body that holds a conveyance object and reciprocates it on a predetermined conveyance path; a drive mechanism that drives the reciprocating body along the conveyance path; an origin sensor that is switched from a first output state to a second output state by the reciprocating body's reaching a predetermined position on the conveyance path; a control circuit for controlling an operation of the drive mechanism; a drive amount detection unit for detecting a drive amount of a power source of the drive mechanism; and a movement detection unit for optically detecting a point of time that the reciprocating body shifts from a resting state to a moving state.

The control circuit includes a movement control unit that moves the reciprocating body in one direction until the origin sensor is switched from the first output state (e.g. the OFF state) to the second output state (e.g. the ON state) and then moves the reciprocating body in an opposite direction of the one direction until the origin sensor is switched from the second output state (e.g. the ON state) to the first output state (e.g. the OFF state) in performing a positioning control of the reciprocating body; a drive amount acquisition unit that acquires, in the course of moving the reciprocating body by a control of the movement control unit, a first drive amount detected by the drive amount detection unit from a point of time that the origin sensor turns to the second output state (e.g. the ON state) and the reciprocating body starts moving in the opposite direction until a point of time that shifting of the reciprocating body from the resting state to the moving state is detected by the movement detection unit, and a second drive amount detected by the drive amount detection unit from the point of time that the shifting of the reciprocating body from the resting state to the moving state is detected by the movement detection unit until a point of time that the origin sensor turns to the first output state (e.g. the OFF state), in which a control operation is performed taking into consideration the acquired first and second drive amounts in the positioning control of the reciprocating body.

Here, the first drive amount represents an amount of a feed amount error of the drive mechanism and the second drive amount represents an amount of a position detection error of the origin sensor.

In some embodiments, the origin sensor is provided on the conveyance path, and it changes from the first output state (e.g. the OFF state) to the second output state (e.g. the ON state) with approaching of a shield plate placed on the reciprocating body, and changes from the second output state (e.g. the ON state) to the first output state (e.g. the OFF state) with leaving of the shield plate.

In further embodiments, the movement detection unit is composed of a test target provided on the reciprocating body and an image pickup device for capturing an image of the test target, in which in the course of moving the reciprocating body in the opposite direction from the second output state of the origin sensor to the first output state of the origin sensor, the image pickup device continuously captures images of the test pattern, and in which the movement detection unit determines that the reciprocating body has shifted from the resting state to the moving state when change occurs in the captured image.

Another aspect of the present invention is a control method of a conveyance device, in which the conveyance device includes: a reciprocating body that holds a conveyance object and reciprocates it on a predetermined conveyance path; a drive mechanism that drives the reciprocating body along the conveyance path; an origin sensor that is switched from a first output state (e.g. the OFF state) to a second output state (e.g. the ON state) by the reciprocating body's reaching a predetermined position on the conveyance path; a drive amount detection unit for detecting a drive amount of a power source of the drive mechanism; and a movement detection unit for optically detecting a point of time that the reciprocating body shifts from a resting state to a moving state, in which the control method includes a first process of moving the reciprocating body in one direction until the origin sensor is switched from the first output state (e.g. the OFF state) to the second output state (e.g. the ON state) and resetting the drive amount detection unit at a point of time that the origin sensor becomes the second output state (e.g. the ON state); thereafter, in the course of moving the reciprocating body in an opposite direction of the one direction until the origin sensor is switched from the second output state (e.g. the ON state) to the first output state (e.g. the OFF state), a second process of monitoring an output signal of the movement detection unit and acquiring a first detection amount (a first count value α) from the drive amount detection unit at a point of time that the reciprocating body shifts from the resting state to the moving state; thereafter, a third process of acquiring a second detection amount (a second count value γ) from the drive amount detection unit at a point of time that the origin sensor turns to the first output state (e.g. the OFF state); and a fourth process of deriving, from the first and second detection amounts (α and γ), a feed amount error of the drive mechanism due to change of the movement direction of the reciprocating body, and a position detection error due to a response difference of the origin sensor between switching from the first output state to the second output state and switching from the second output state to the first output state, and in which a positioning control of the reciprocating body is performed by taking into consideration the derived feed amount error and the derived position detection error.

Still another aspect of the present invention is a control program of a conveyance device, in which the conveyance device includes: a reciprocating body that holds a conveyance object and reciprocates it on a predetermined conveyance path; a drive mechanism that drives the reciprocating body along the conveyance path; an origin sensor that is switched from a first output state (e.g. the OFF state) to a second output state (e.g. the ON state) by the reciprocating body's reaching a predetermined position on the conveyance path; a drive amount detection unit for detecting a drive amount of a power source of the drive mechanism; and a movement detection unit for optically detecting a point of time that the reciprocating body shifts from a resting state to a moving state, in which the control program causes a computer to execute a first process of moving the reciprocating body in one direction until the origin sensor is switched from the first output state (e.g. the OFF state) to the second output state (e.g. the ON state) and resetting the drive amount detection unit at a point of time that the origin sensor turns to the second output state (e.g. the ON state); thereafter in the course of moving the reciprocating body in an opposite direction of the one direction until the origin sensor is switched from the second output state (e.g. the ON state) to the first output state (e.g. the OFF state), a second process of monitoring an output signal of the movement detection unit and acquiring a first detection amount (a first count value α) from the drive amount detection unit at a point of time that the reciprocating body shifts from the resting state to the moving state; thereafter, a third process of acquiring a second detection amount (a second count value γ) from the drive amount detection unit at a point of time that the origin sensor turns to the first output state (e.g. the OFF state); and a fourth process of deriving, from the first and second detection amounts (α and γ), a feed amount error of the drive mechanism due to change of the movement direction of the reciprocating body, and a position detection error due to a response difference of the origin sensor between switching from the first output state to the second output state and switching from the second output state to the first output state, and in which a positioning control of the reciprocating body is performed by taking into consideration the derived feed amount error and the derived position detection error.

Still another aspect of the present invention is an observation device, which includes a reciprocating body that holds a conveyance object and reciprocates it on a predetermined conveyance path; a drive mechanism that drives the reciprocating body along the conveyance path; an image pickup device for capturing an image of an observation object held on the reciprocating body when the reciprocating body has reached a predetermined observation position on the conveyance path; an origin sensor that is switched from a first output state (e.g. the OFF state) to a second output state (e.g. the ON state) by the reciprocating body's reaching a predetermined position on the conveyance path; a drive amount detection unit for detecting a drive amount of a power source of the drive mechanism; a movement detection unit for optically detecting a point of time that the reciprocating body shifts from a resting state to a moving state; and a control circuit for controlling an operation of the drive mechanism, in which a test target whose image is captured by the observation device is provided on the reciprocating body, in which the movement detection unit determines that the reciprocating body has shifted from the resting state to the moving state at a point of time that change occurs in the image of the test target captured by the image pickup device, and in which the control circuit includes a movement control unit that moves the reciprocating body in one direction until the origin sensor is switched from the first output state (e.g. the OFF state) to the second output state (e.g. the ON state) and then moves the reciprocating body in an opposite direction of the one direction until the origin sensor is switched from the second output state (e.g. the ON state) to the first output state (e.g. the OFF state) in performing a positioning control of the reciprocating body; and a drive amount acquisition unit that acquires a first drive amount detected by the drive amount detection unit from a point of time that the origin sensor turns to the second output state (e.g. the ON state) and the reciprocating body moves in the opposite direction until a point of time that the shifting of the reciprocating body from the resting state to the moving state is detected by the movement detection unit, and a second drive amount detected by the drive amount detection unit from the point of time that the shifting of the reciprocating body from the resting state to the moving state is detected by the movement detection unit until a point of time that the origin sensor turns to the first output state (e.g. the OFF state), in the course of moving the reciprocating body controlled by the movement control unit, and in which a control operation is performed taking into consideration the acquired first drive amount and the acquired second drive amount in the positioning control of the reciprocating body.

In the conveyance control device, the control method of the conveyance device, and the observation device according to the invention, when performing a positioning control of the reciprocating body, in the course of moving the reciprocating body in one direction until the origin sensor is switched from the first output state (e.g. the OFF state) to the second output state (e.g. the ON state) and then resetting the drive amount detection unit (e.g. an internal counter) at a point of time that the origin sensor turns to the second output state (e.g. the ON state), and thereafter moving the reciprocating body in an opposite direction of the one direction until the origin sensor is switched from the second output state (e.g. the ON state) to the first output state (e.g. the OFF state), a detection value (e.g. a count value α of the internal counter) is acquired by the drive amount detection unit at a point of time that the reciprocating body shifts from the resting state to the moving state. The acquired first detection value α represents a feed amount error of the drive mechanism caused by the change of the movement direction of the reciprocating body that is an amount of the backlash.

Thereafter, in the course of moving the reciprocating body in the opposite direction, a detection value (e.g. a count value γ of the internal counter) is acquired by the drive amount detection unit at a point of time that the origin sensor is switched from the second output state (e.g. the ON state) to the first output state (e.g. the OFF state). The acquired second detection value γ represents the sum of the feed amount error of the drive mechanism and the position detection error of the origin sensor, and thus, the difference β obtained by subtraction of the first detection value α from the second detection value γ represents an amount of the position detection error of the origin sensor.

After the feed amount error of the drive mechanism and the position detection error of the origin sensor are derived as such, a control operation is performed by taking into consideration the derived feed amount error and the derived position detection error in the positioning control of the reciprocating body.

### BRIEF DESCRIPTION OF THE DRAWINGS

FIG. 1 is a perspective view showing external appearance of an observation device according to an embodiment of the present invention.

FIG. 2 is a view showing an internal structure of the observation device.

FIG. 3 is a plan view of an X-axis drive mechanism and a Y-axis drive mechanism according to an embodiment.

FIG. 4 is a front view of the X-axis drive mechanism and the Y-axis drive mechanism.

FIG. 5 is a side view of the X-axis drive mechanism and the Y-axis drive mechanism.

FIG. 6 is a block diagram showing a structure of the observation device.

FIG. 7 is a plan view showing a positional relationship of a holder, an X-axis sensor, and an X-axis shield plate at an origin position according to an embodiment.

FIGS. 8A to 8C are views for explaining switching between the ON/OFF state of the X-axis sensor.

FIGS. 9A and 9B are views showing a positional relationship between the X-axis sensor and the X-axis shield plate (9A) and a captured image of a test target (9B) at a first phase of an origin return operation.

FIGS. 10A and 10B are views showing a positional relationship between the X-axis sensor and the X-axis shield plate (10A) and change with the captured image of the test target (10B) at a second phase of the origin return operation.

FIG. 11 is a view showing a positional relationship between the X-axis sensor and the X-axis shield plate at a third phase of the origin return operation.

FIG. 12 is a view showing a positional relationship between the X-axis sensor and the X-axis shield plate at a fourth phase of the origin return operation.

FIG. 13 is a flowchart showing a control process of the observation device according to the present invention.

FIG. 14 is a flowchart showing a control process of the origin return operation.

FIG. 15 is a flowchart showing a control process of feed amount error computation.

FIG. 16 is a flowchart showing a control process of position detection error computation.

FIG. 17 is a flowchart showing an alternative control process of the origin return operation.

FIG. 18 is a flowchart showing a control process of an alternative control process of the observation device according to the present invention.

FIG. 19 is a flowchart showing a control process of the origin return operation.

FIGS. 20A to 20C are a plan view (20A), a front view (20B), and a side view (20C) showing a first phase of an origin return operation.

FIGS. 21A to 21C are a plan view (21A), a front view (21B), and a side view (21C) showing a second phase of the origin return operation.

FIGS. 22A to 22C are a plan view (22A), a front view (22B), and a side view (22C) showing a third phase of the origin return operation.

FIGS. 23A to 23C are a plan view (23A), a front view (23B), and a side view (23C) showing a fourth phase of the origin return operation.

FIGS. 24A to 24C are a plan view (24A), a front view (24B), and a side view (24C) showing a first phase of an operation to compute the feed amount error and the position detection error.

FIGS. 25A to 25C are a plan view (25A), a front view (25B), and a side view (25C) showing a second phase of the operation to compute the feed amount error and the position detection error.

FIGS. 26A to 26C are a plan view (26A), a front view (26B), and a side view (26C) showing a third phase of the operation to compute the feed amount error and the position detection error.

FIGS. 27A to 27C are a plan view (27A), a front view (27B), and a side view (27C) showing a fourth phase of the operation to compute the feed amount error and the position detection error.

FIGS. 28A to 28C are a plan view (28A), a front view (28B), and a side view (28C) showing a fifth phase of the operation to compute the feed amount error and the position detection error.

FIG. 29 is a view showing an example of a positioning control taking into consideration the feed amount error.

FIGS. 30A and 30B are views showing an example of the positioning control taking into consideration the position detection error.

### DETAILED DESCRIPTION OF THE INVENTION

Specific embodiments in which the present invention is performed in an observation device will be described hereinafter by referring to the drawings.

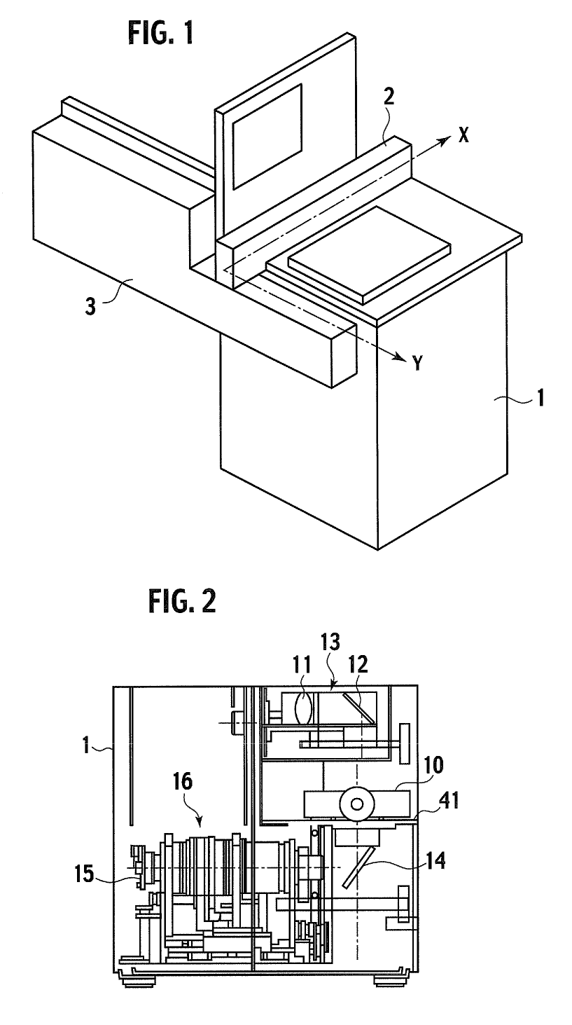

The observation device according to an embodiment of the invention is for observing an object such as a cell stained with fluorescent reagent. As shown in FIGS. 1 and 2, a stage 41 on which a flask 10 that holds an observation object is to be placed is provided within a housing 1, and the stage 41 can be reciprocated in an X-axis direction and in a Y-axis direction on a horizontal plane by an X-axis drive mechanism 2 and a Y-axis drive mechanism 3.

Within the housing 1, an illuminating device 13 having an LED 11 and a mirror 12 is provided for illuminating the flask 10, and an image pickup device 16 having a CCD 15 and a mirror 14 also is provided for capturing an image of the flask 10.

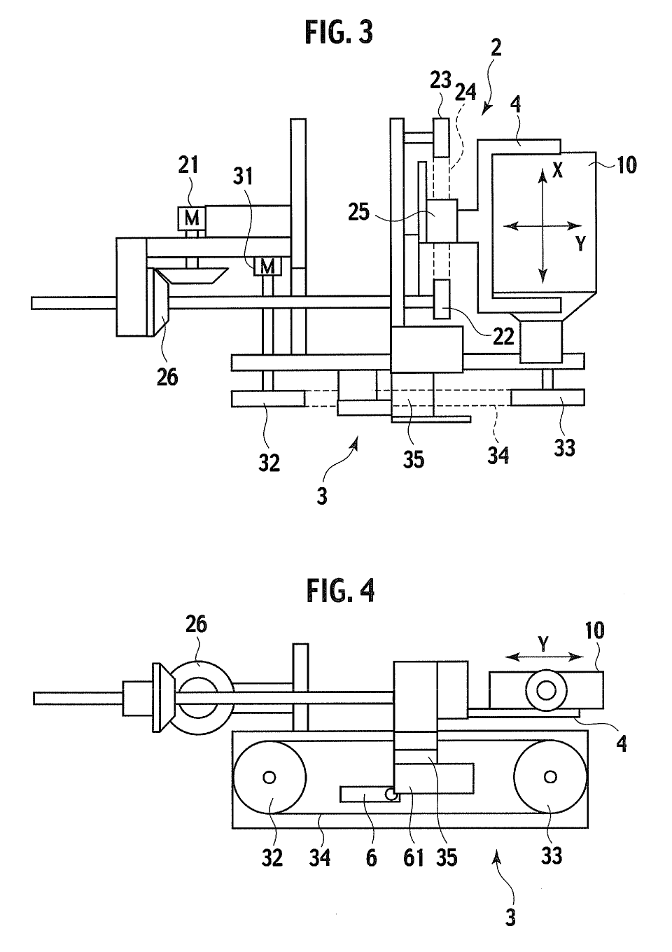

As shown in FIGS. 3 to 5, the X-axis drive mechanism 2 includes an X-axis motor 21 as a power source. Rotation of the X-axis motor 21 is converted to reciprocating motion of an X-axis sliding body 25 connected to a timing belt 24 through a gear mechanism 26 and a pulley mechanism composed of pulleys 22, 23 and the timing belt 24. The holder 4 is driven in the X-axis direction by the reciprocating motion of the X-axis sliding body 25.

Also, the Y-axis drive mechanism 3 has a Y-axis motor 31 as a power source. Rotation of the Y-axis motor 31 is converted to reciprocating motion of a Y-axis sliding body 35 connected to a timing belt 34 through a pulley mechanism composed of pulleys 32, 33 and the timing belt 34. The holder 4 is driven in the Y-axis direction by the reciprocating motion of the Y-axis sliding body 35.

As shown in FIG. 3, the holder 4 holds the flask 10, and the flask 10 held by the holder 4 moves in the Y-axis direction driven by the Y-axis drive mechanism 3 while moving in the X-axis direction driven by the X-axis drive mechanism 2.

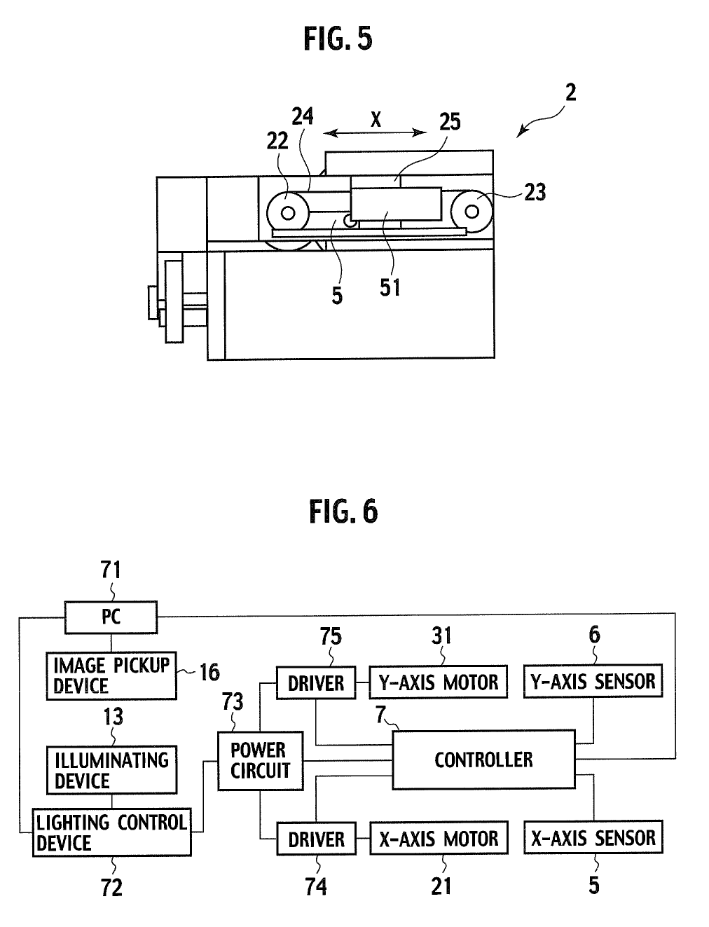

As shown in FIG. 5, an X-axis sensor 5 is provided in the X-axis drive mechanism 2 for detecting an origin position of the X-axis sliding body 25 in the X-axis direction. The X-axis sensor 5 is switched between the ON/OFF state by approaching and leaving of an X-axis shield plate 51 connected to the X-axis sliding body 25.

As shown in FIG. 4, a Y-axis sensor 6 is provided in the Y-axis drive mechanism 3 for detecting an origin position of the Y-axis sliding body 35 in the Y-axis direction. The Y-axis sensor 6 is switched between the ON/OFF state by approaching and leaving of a Y-axis shield plate 61 connected to the Y-axis sliding body 35.

An inductive proximity sensor is used as the X-axis sensor 5 and the Y-axis sensor 6, which causes a detection coil to generate a magnetic field and detects change in impedance by approaching of a detection object.

As shown in FIG. 6, output signals of the X-axis sensor 5 and the Y-axis sensor 6 are supplied to a controller 7, and the X-axis motor 21 and the Y-axis motor 31 are driven by drive control signals (drive pulses) generated at the controller 7, which are supplied to drivers 74 and 75. Electric power is supplied to the drivers 74 and 75 from a power circuit 73.

In addition, the X-axis motor 21 and the Y-axis motor 31 respectively are stepping motors, and a drive amount of each motor can be accurately measured by counting the number of drive pulses supplied from the controller 7 using an internal counter.

Also, the illuminating device 13 is controlled at a lighting control circuit 72, and necessary electric power is supplied to the lighting control circuit 72 from the power circuit 73.

Moreover, command signals sent by an operation of a user on a personal computer 71 are supplied to the image pickup device 16, the lighting control circuit 72, and the controller 7, by which a control is performed on capturing an image of the observation object by the image pickup device 16, illuminating the observation object by the illuminating device 13, and driving the X-axis motor 21 and the Y-axis motor 31. Power can be supplied to the image pickup device 16 from the personal computer 71 or from the power circuit 73.

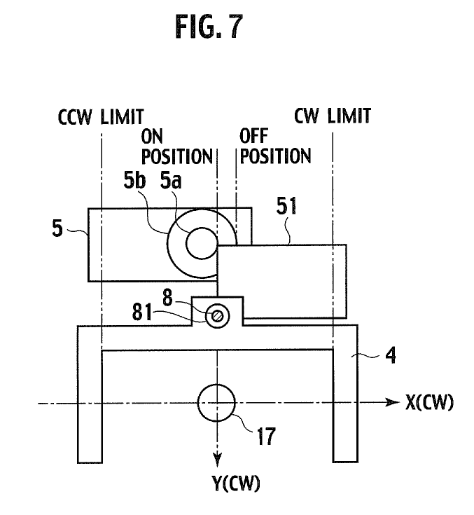

As shown in FIG. 7, a test target 8 is provided on the holder 4. The test target 8 is formed by providing a circular mark on a transparent glass part 81 e.g. by vapor deposition, and an image of the test target 8 can be captured by moving the holder 4 in the Y-axis direction and bringing the test target 8 so as to come within an image capturing range 17 of the image pickup device 16.

FIG. 7 shows a state in which the holder 4 is placed in an origin position. At the origin position, it is constructed such that the center of the flask held by the holder 4 comes within the image capturing range 17. By moving the holder 4 from this state in the Y-axis direction (the CW direction), the test target 8 can be placed within the image capturing range 17.

As shown in FIG. 7, the X-axis sensor 5 is turned on when the X-axis shield plate 51 moves in the CCW direction and reaches the ON position, and thereafter, the X-axis sensor 5 is turned off when the X-axis shield plate 51 moves in the CW direction and reaches the off position. Thus, sensors have a gap between the range 5a at which the X-axis sensor 5 is turned ON from the OFF state and the range 5b at which the X-axis sensor is turned off from the ON state.

When the holder 4 moves a predetermined distance in the CW direction from the origin position as shown in FIG. 7, a CW limit is placed by software on the movement of the holder 4. Also, when the holder 4 moves a predetermined distance in the CCW direction from the origin position, a CCW limit is placed by software on the movement of the holder 4. The Y-axis sensor 6 has a similar structure also.

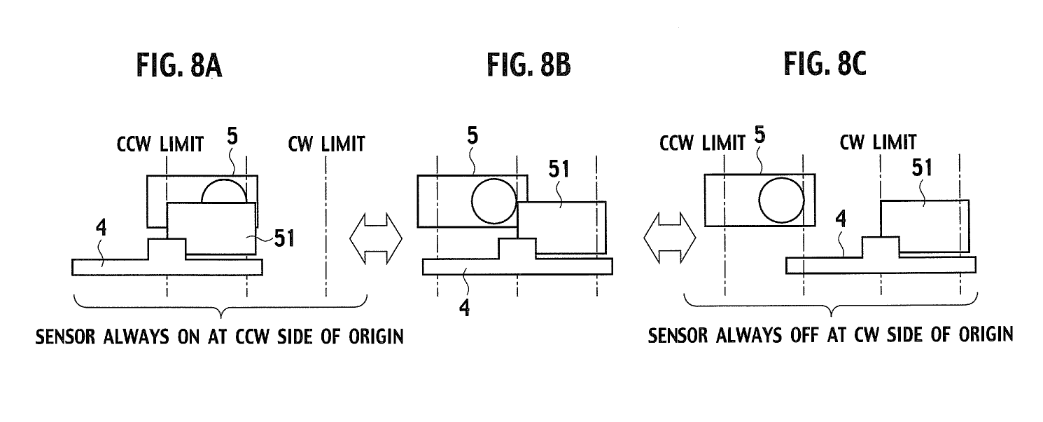

As shown in FIGS. 8A to 8C, the X-axis shield plate 51 is formed such that it is elongated in the X-axis direction, and it is set up such that when it is on the CCW side from the origin position as shown in FIG. 8B, the X-axis sensor 5 is always in the ON state, and when it is on the CW side from the origin position as shown in FIG. 8C, the X-axis sensor 5 is always in the OFF state. The Y-axis shield plate 61 has a similar structure also.

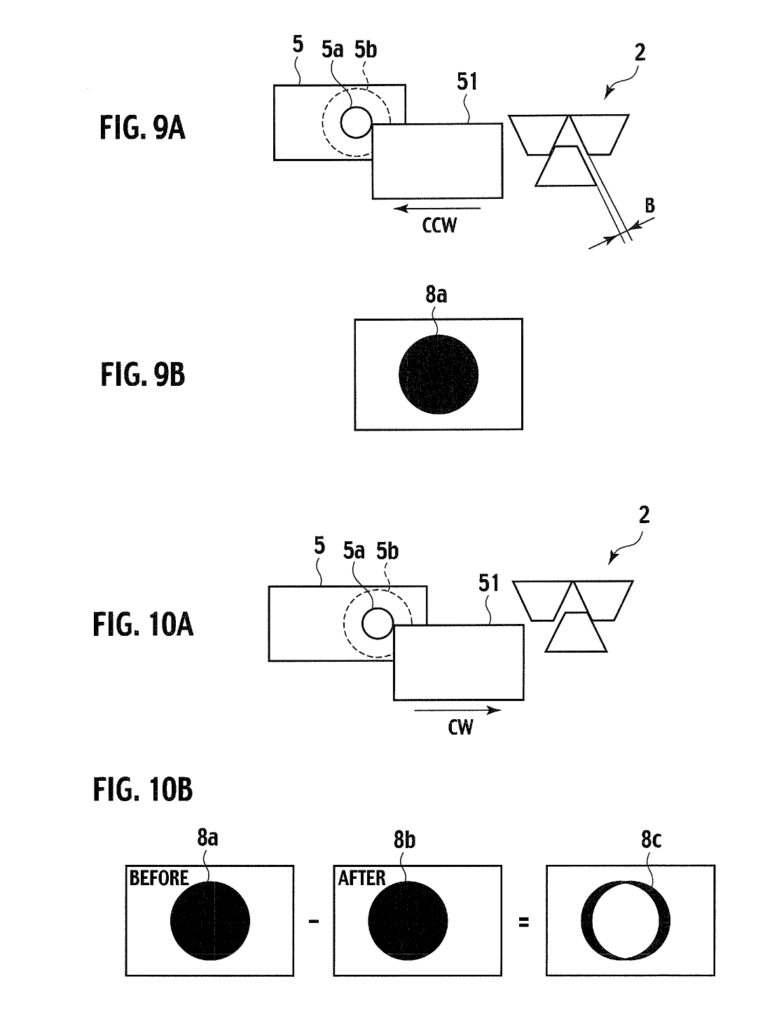

In the observation device according to the present invention, after the power is activated, as shown in FIG. 9A, the X-axis motor 21 is rotated in the CCW direction until the X-axis sensor 5 is turned to the ON state from the OFF state thereby moving the X-axis shield plate 51, and the X-axis shield plate 51 is stopped at a point that the X-axis sensor 5 is turned on. In this state, a backlash B is occurring in the X-axis drive mechanism 2.

At this point, the holder 4 is moved in the Y-axis direction and an image of the test target 8 is captured as shown in FIG. 9B in a state that the test target 8 comes within the image capturing range 17. At the same time, the internal counter is reset.

Next, as shown in FIG. 10A, the X-axis motor 21 is reversed in the CW direction and an image of the test target 8 is captured continuously. At this time, the X-axis motor 21 runs idle and the X-axis shield plate 51 remains stopped until the backlash B of the X-axis drive mechanism 2 is cleared up, and at a point of time that the backlash B of the X-axis drive mechanism 2 is eliminated, the X-axis shield plate 51 starts moving.

After the X-axis shield plate 51 starts moving, the captured image 8b of the test target 8 is shifted from the captured image 8a of the test target 8 before the X-axis shield plate 51 started moving, and thus, as shown in FIG. 10B, if a difference is taken between the captured image 8a before the start of moving and the captured image 8b after the start of moving, a difference image 8c can be obtained, which has a dimension greater than or equal to a certain value. On the other hand, if a difference image 8c having such a dimension is not obtained, it can be determined that the test target 8 is in a resting state.

Thus, the image of the test target 8 is captured continuously starting immediately after the X-axis motor 21 is reversed and the difference between the captured image 8a before the start of moving and the captured image 8b thereafter is computed. At a point that the difference image 8c having the dimension greater than or equal to a certain value is obtained, it is determined that the backlash has been eliminated and a count value α is taken in, which is obtained by subtracting 1 from the count value of the internal counter at that time. Therefore, the count value α represents the amount of the backlash of the X-axis drive mechanism 2.

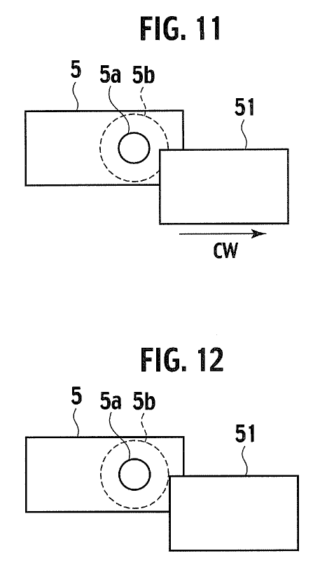

Thereafter, as shown in FIG. 11, the X-axis shield plate 51 is moved further in the CW direction, and at a point that the X-axis sensor 5 is turned to the OFF state from the ON state, the X-axis shield plate 51 is stopped and at the same time a count value γ is taken in, which is obtained by subtracting 1 from the count value of the internal counter at that time. The count value γ represents the sum of the backlash of the X-axis drive mechanism 2 and the position detection error of the X-axis sensor 5.

Therefore, by subtracting the count value α from the count value γ, the difference β of the count values represents the amount of the position detection error of the X-axis sensor 5.

With respect to the Y-axis drive mechanism 3, the count value α corresponding to the backlash of the Y-axis drive mechanism 3 and the count value difference β corresponding to the position detection error of the Y-axis sensor 6 also can be derived through a similar process.

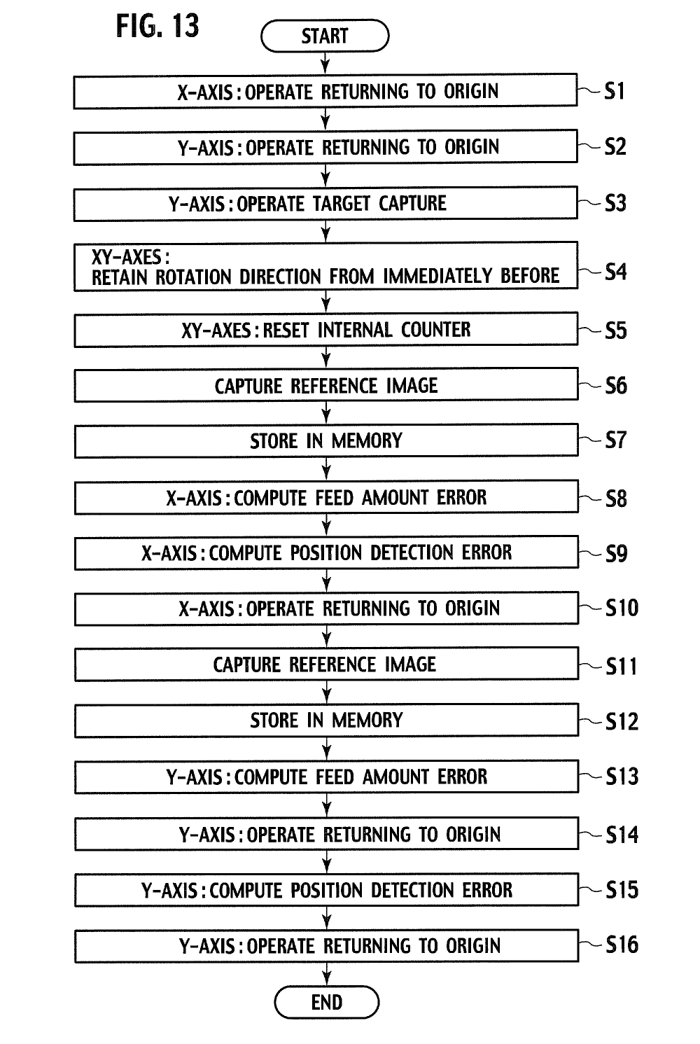

FIG. 13 shows a process for deriving the feed amount errors due to the backlashes with respect to the X-axis drive mechanism and the Y-axis drive mechanism and the position detection errors with respect to the X-axis sensor and the Y-axis sensor, and for returning the flask as the observation object to the observation starting position (origin position).

After the system is activated, first, at step S1, a return to origin operation is performed with respect to the X-axis drive mechanism. At step S2, a return to origin operation is performed with respect to the Y-axis drive mechanism.

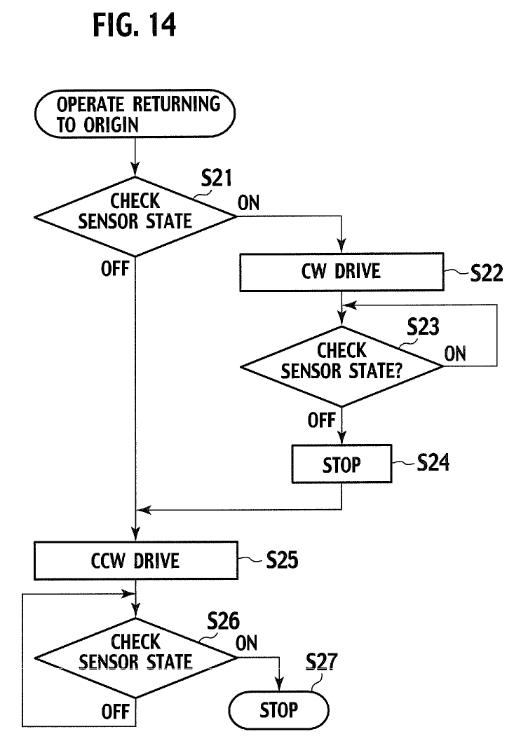

At each of the return to origin operations, as shown in FIG. 14, at step S21, an output state of the sensor is checked and if the sensor is in the OFF state, at step S25, the drive mechanism is driven in the CCW direction.

If the sensor is in the ON state, the process advances to step S22, and after the drive mechanism is driven in the CW direction, at step S23, the output state of the sensor is checked and driving in the CW direction is maintained until the sensor is turned off.

When the sensor thus is turned off, at step S24, the drive mechanism is stopped, and then, at step S25, the drive mechanism is driven in the CCW direction.

Thereafter, at step S26, the output state of the sensor is checked, and at a point that the sensor is turned on, the process advances to step S27 and the drive mechanism is stopped.

As a result, the X-axis drive mechanism and the Y-axis drive mechanism respectively return to the origin position (see FIG. 7) and the rotation directions of the motors before stopping become the same. Also, the output states of the sensors both become in the ON state.

After the return to origin operations of the X-axis drive mechanism and the Y-axis drive mechanism are completed, at step S3 of FIG. 13, the Y-axis drive mechanism is operated and a target capturing operation is performed which places the test target 8 within the image capturing range 17, as shown in FIG. 7. At this time, since the drive amount of the Y-axis motor generally is set according to the structure of the Y-axis drive mechanism, the Y-axis motor can be stopped after being rotated in the CW direction as much as a predetermined amount.

Thereafter, at step S4 of FIG. 13, with respect to the X-axis drive mechanism and the Y-axis drive mechanism, the rotation directions (CW, CCW) of the motors immediately before stopping are retained. The retention of the rotation directions of immediately before stopping may be implemented each time the driving is stopped with respect to each axis.

Subsequently, at step S5, with respect to the X-axis drive mechanism and the Y-axis drive mechanism, the internal counters are reset to zero, which count the number of drive pulses of the respective motors.

The process of steps S1 to S5 may be performed in succession with respect to the X-axis and the Y-axis or it maybe performed in parallel. Next, at step S6, an image of the test target is captured as a reference image and the result is stored in a memory at step S7.

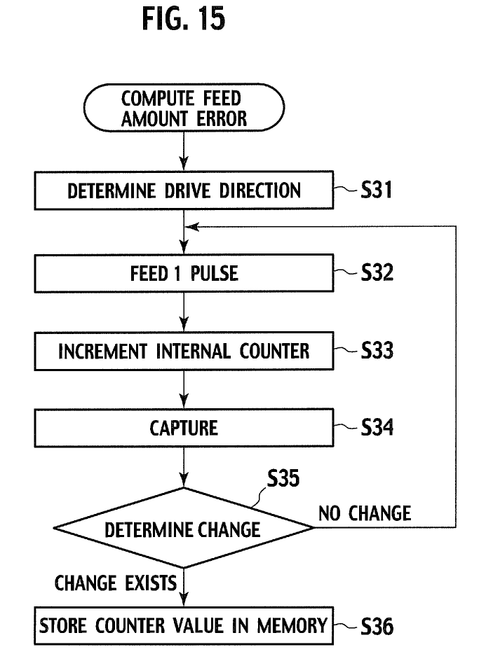

Thereafter, at step S8, the feed amount error caused by a backlash of the X-axis drive mechanism is computed. In computing the feed amount error, as shown in FIG. 15, at step S31, the rotation direction of immediately before is read out, determining its opposite direction as the motor drive direction, and at step S32, the motor is driven as much as 1 pulse. Then at step S33, the internal counter is incremented, and thereafter at step S34, an image of the test target is captured.

At step S35, a differential processing is performed with respect to the reference image stored in the memory and the image captured at step S34, and it is determined whether or not change exists between the two images. If it is determined that no change exists, it is considered that the driving of the 1 pulse immediately before was lost motion (the backlash is occurring), and the process returns to step S32 to repeat the process from S32 to S35.

On the other hand, if it is determined that change exists at step S35, it is considered that the backlash has been cleared up, and at step S36, the count value α is stored in the memory as the feed amount error, which is a value that 1 is subtracted from the count value at that time.

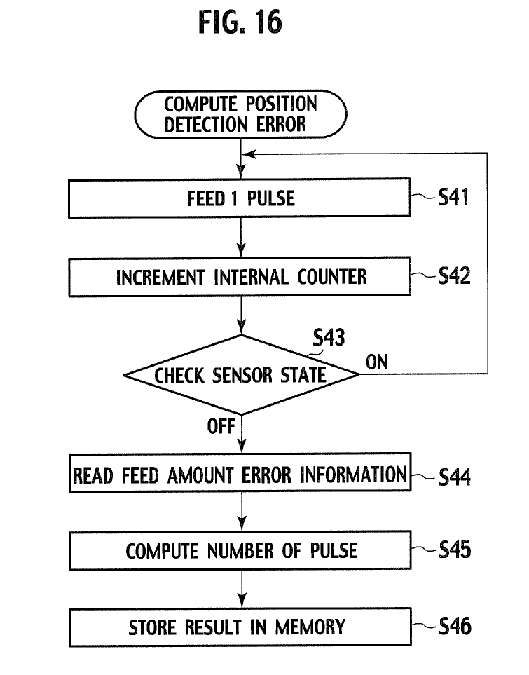

Thereafter, at step S9 of FIG. 13, the position detection error with respect to the X-axis is computed. In computing the position detection error, as shown in FIG. 16, at step S41, the motor is driven as much as 1 pulse in the same direction as the drive direction determined at the time of computing the feed amount error, and then at step S42, the internal counter is incremented. Then, at step S43, the output state of the sensor is checked and if it is in the ON state, the process returns to step S41 and repeats the 1 pulse driving of the motor.

If the sensor is turned off at step S43, it is considered that the position detection error of the sensor is resolved, and at step S44, feed amount error information (the count value α) is read out from the memory, and at step S45, the number of pulses representing the position detection error amount (position detection error information) β is computed by subtracting the count value α representing the feed amount error from the count value γ, which is a value that 1 is subtracted from the current count value of the internal counter, and at step S46, the result is stored in the memory.

Thereafter, at step S10 of FIG. 13, a return to origin operation is performed with respect to the X-axis, and then at step S11, an image of the test target is captured as a reference image, and its result is stored in the memory at step S12.

Thereafter, at step S13, a feed amount error caused by a backlash of the Y-axis drive mechanism is computed (see FIG. 15). Furthermore, at step S14, a return to origin operation is performed, and then at step S15, the position detection error with respect to the Y-axis is computed (see FIG. 16). Lastly, at step S16, a return to origin operation is performed with respect to the Y-axis and the sequence of the process is completed.

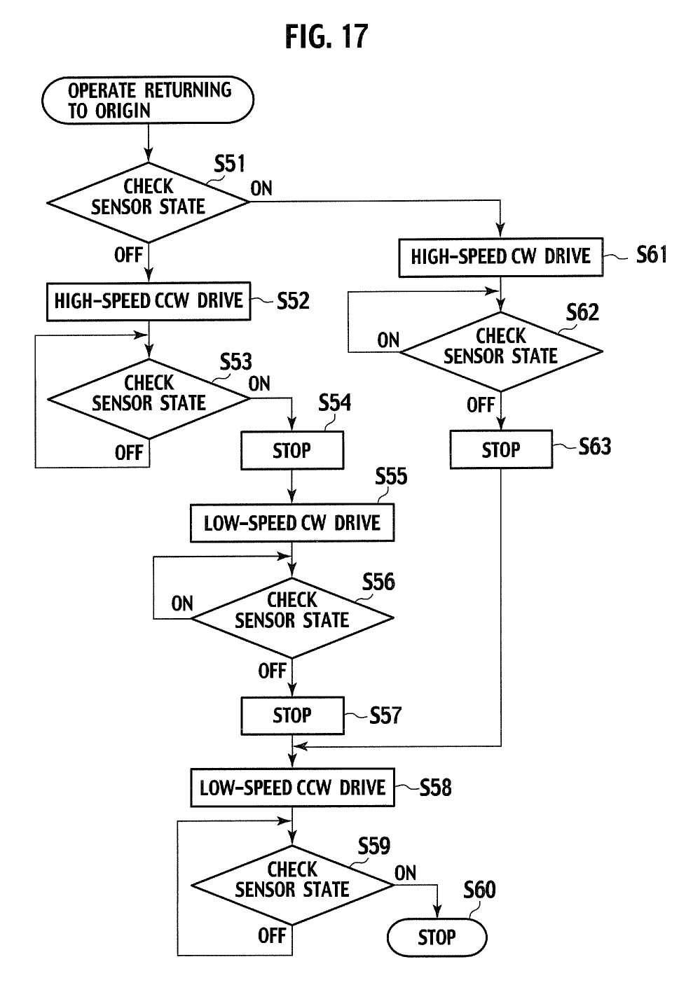

The return to origin operation also can be performed by the process as shown in FIG. 17. First, at step S51, the output state of the sensor is checked. If the sensor is in the OFF state, at step S52, the drive mechanism is driven at high speed in the CCW direction.

Thereafter, at step S53, the output state of the sensor is checked and the driving at high speed in the CCW direction is maintained until the sensor is turned to the ON state.

When the sensor thus is turned on, at step S54, the drive mechanism is stopped, and then at step S55, the drive mechanism is driven at low speed in the CW direction.

Moreover, at step S56, the output state of the sensor is checked and the driving at low speed in the CW direction is maintained until the sensor is turned off.

When the sensor thus is turned off, at step S57, the drive mechanism is stopped, and then at step S58, the drive mechanism is driven at low speed in the CCW direction.

On the other hand, when the sensor is in the ON state at step S51, the process advances to step S61 at which the drive mechanism is driven at high speed in the CW direction, and then at step S62, the output state of the sensor is checked and the driving at high speed in the CW direction is maintained until the sensor is turned off.

When the sensor thus is turned off, at step S63, the drive mechanism is stopped, and then at step S58, the drive mechanism is driven at low speed in the CCW direction.

Thereafter, at step S59, the output state of the sensor is checked, and at a point that it is turned to the ON state, the process advances to step S60 and the drive mechanism is stopped.

Thus, the X-axis drive mechanism and the Y-axis drive mechanism rapidly return to the origin position respectively. At this time, even if each shield plate overshoots the ON position because of increased inertia force due to the high-speed driving of the X-axis drive mechanism and the Y-axis drive mechanism, thereafter each shield plate returns to the ON position of the sensor by the low-speed driving.

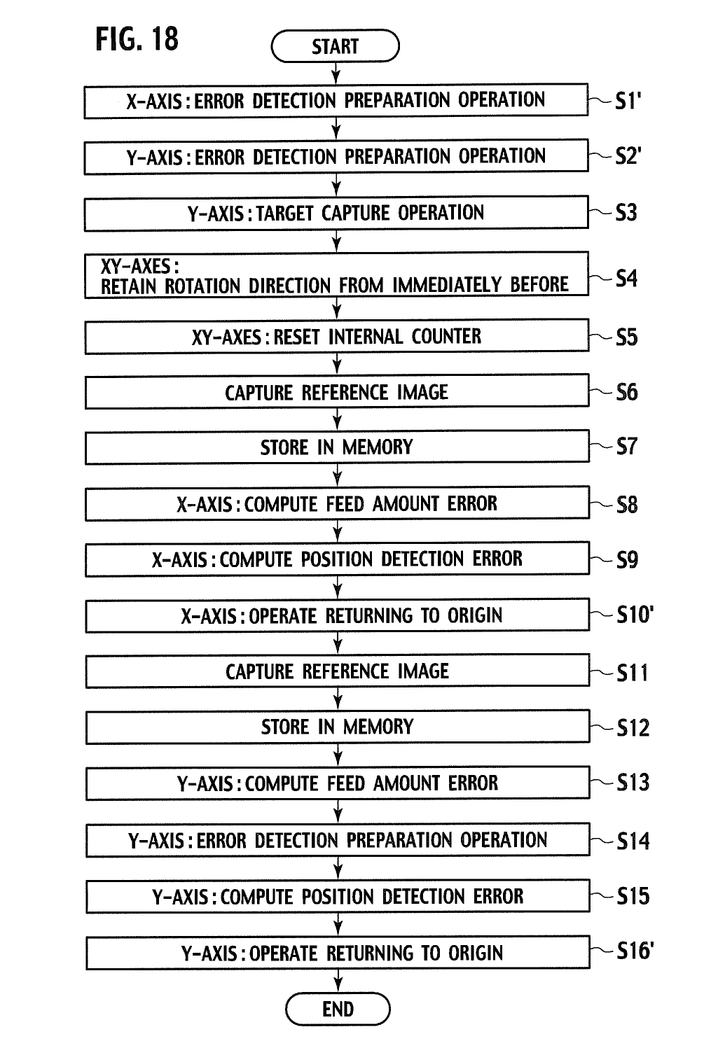

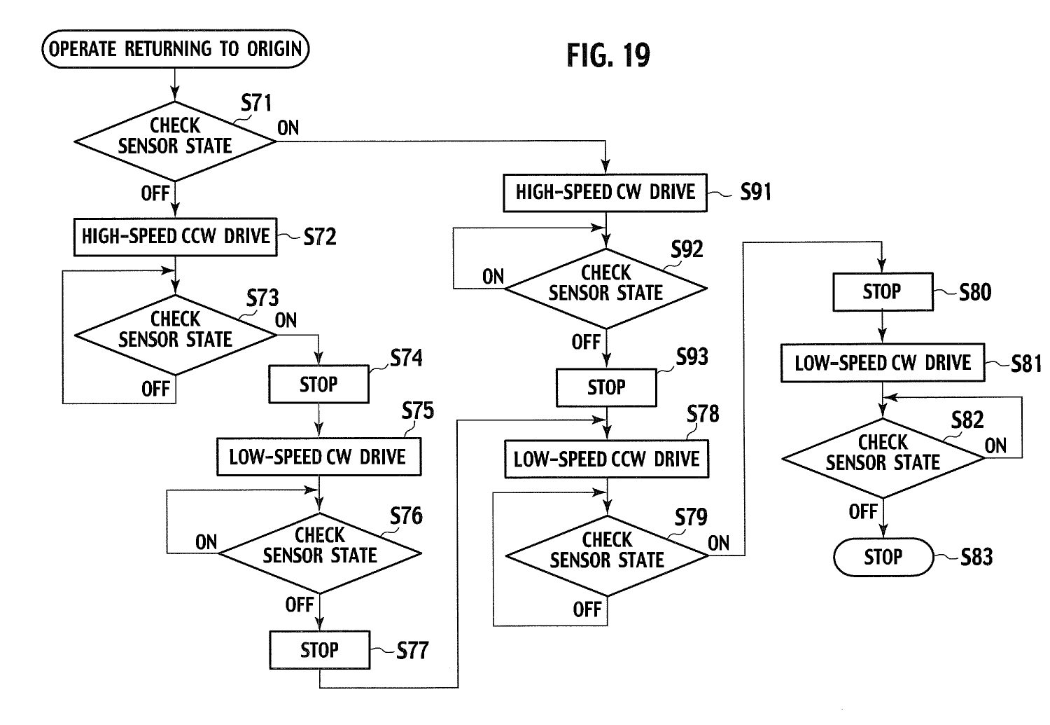

FIG. 18 shows an alternative example of the process as shown in FIG. 13. At step S1′ and step S2′, error detection preparation operations are performed with respect to the X-axis drive mechanism and the Y-axis drive mechanism. This error detection preparation operation is the same as the return to origin operation as shown in FIG. 17. On the other hand, at step S10′ and step S16′, a return to origin operation as shown in FIG. 19 is performed.

At the return to origin operation of FIG. 19, first, at step S71, the output state of the sensor is checked, and if the sensor is in the OFF state, at step S72, the drive mechanism is driven at high speed in the CCW direction.

Thereafter, at step S73, the output state of the sensor is checked and the driving at high speed in the CCW direction is maintained until the sensor is turned to the ON state. When the sensor thus is turned on, at step S74, the drive mechanism is stopped, and then at step S75, the drive mechanism is driven at low speed in the CW direction.

Moreover, at step S76, the output state of the sensor is checked, and the driving at low speed in the CW direction is maintained until the sensor is turned off. When the sensor thus is turned off, at step S77, the drive mechanism is stopped, and then at step S78, the drive mechanism is driven at low speed in the CCW direction.

On the other hand, if the sensor is in the ON state at step S71, the process advances to step S91, and the drive mechanism is driven at high speed in the CW direction, and then at step S92, the output state of the sensor is checked and the driving at high speed in the CW direction is maintained until the sensor is turned off.

When the sensor thus is turned off, at step S93, the drive mechanism is stopped, and then at step S78, the drive mechanism is driven at low speed in the CCW direction. Thereafter, at step S79, the output state of the sensor is checked, and when it is turned to the ON state, the process advances to step S80 at which the drive mechanism is stopped. Thereafter, at step S81, the drive mechanism is driven at low speed in the CW direction, and then at step S82, the output state of the sensor is checked, and at a point when the sensor is turned off, the process advances to step S83 and the drive mechanism is stopped. As such, with the position that the sensor is turned off being the origin, a return to origin operation for returning to that origin is achieved.

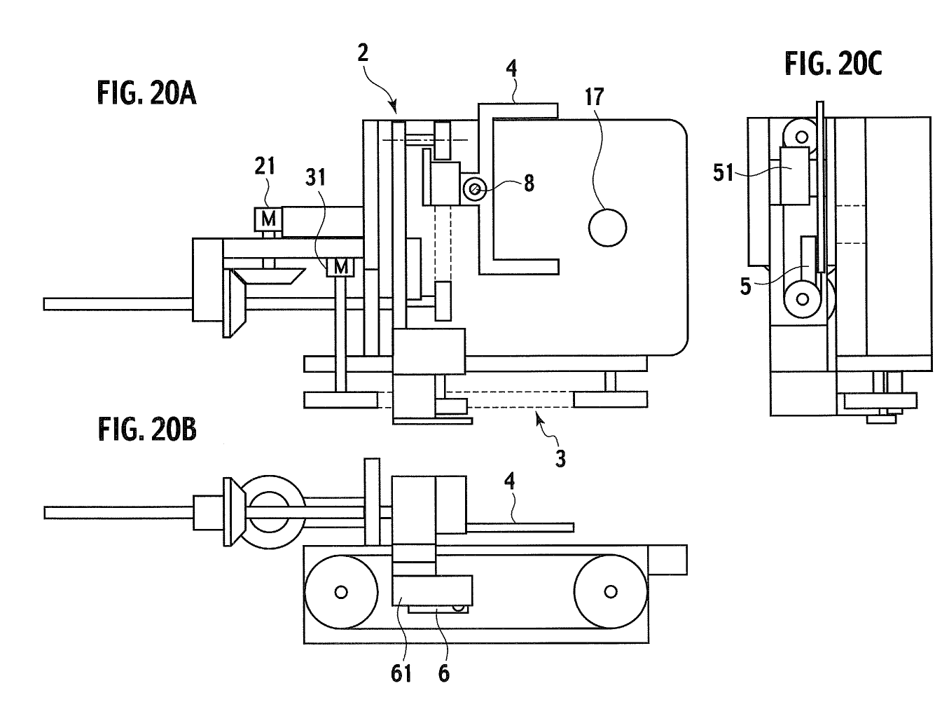

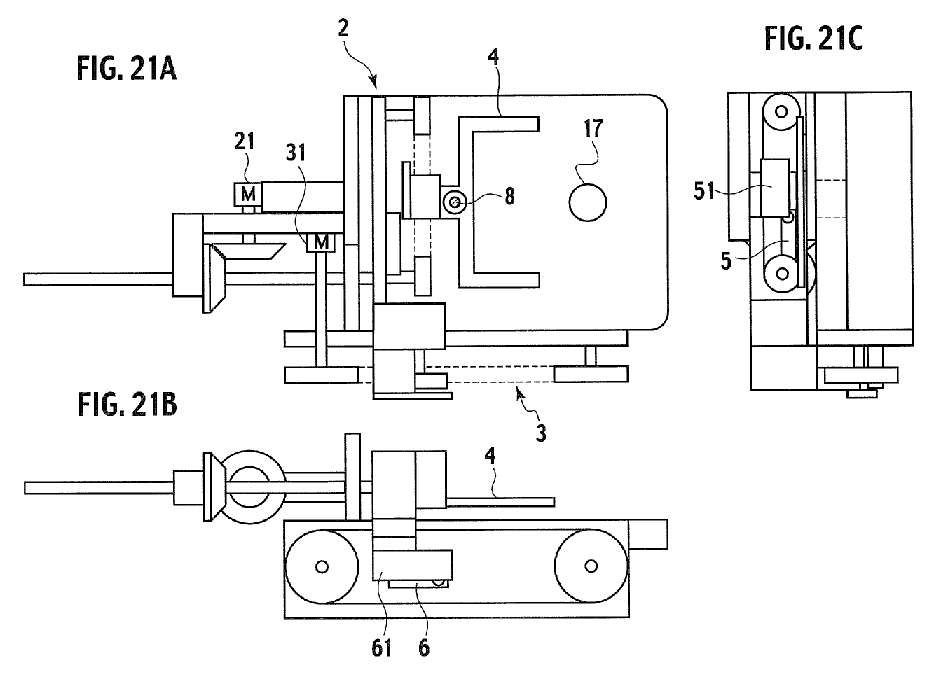

FIGS. 20A-20C to FIGS. 23A-23C show an example of the return to origin operations with a position that the sensor is turned on is set as the origin. FIGS. 20A to 20C show a state in which both the X-axis and the Y-axis are in the limit positions. For example, from this state the return to origin operation is started. At this time, since the X-axis sensor 5 is in the OFF state, and the Y-axis sensor 6 is in the ON state, the X-axis motor 21 of the X-axis drive mechanism 2 is driven in the CCW direction, and thereafter, at a point when the X-axis sensor 5 is turned to the ON state, the X-axis drive mechanism 2 is stopped as shown in FIGS. 21A to 21C.

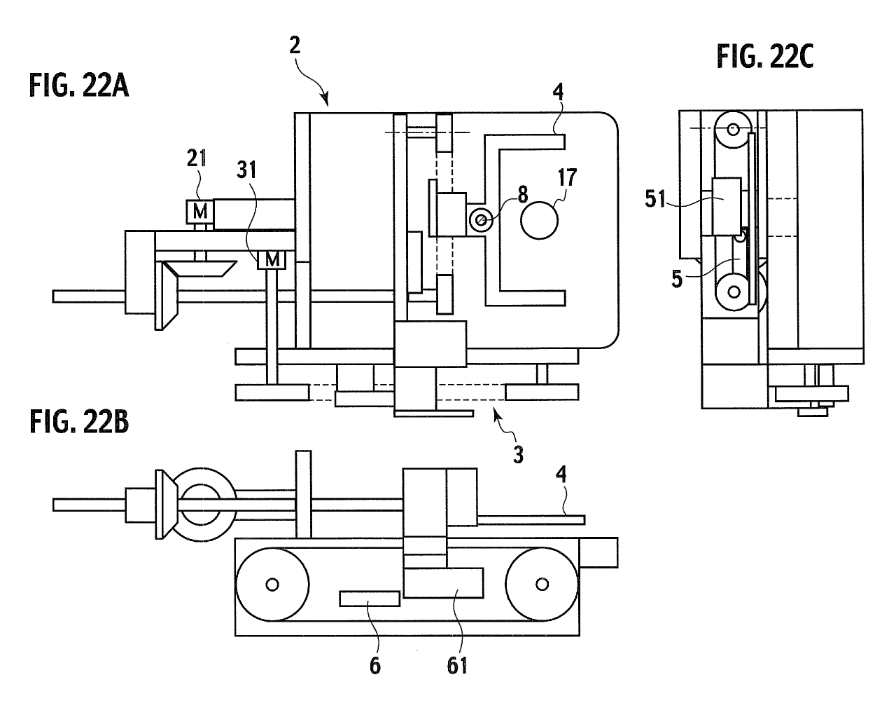

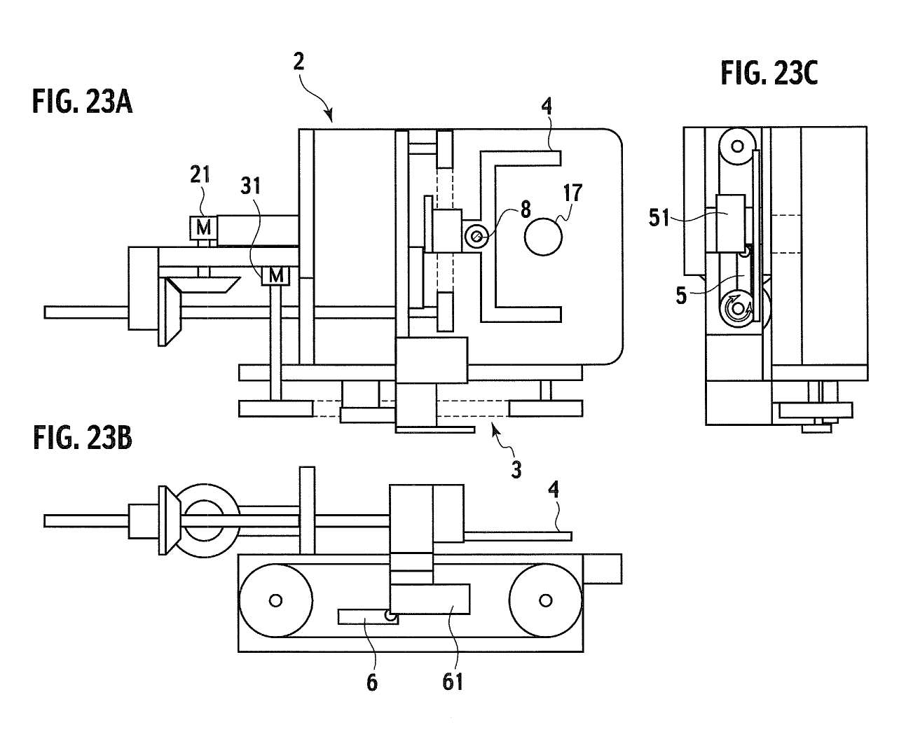

Next, since the Y-axis sensor 6 is in the ON state as shown in FIG. 21, the Y-axis motor 31 of the Y-axis drive mechanism 3 is driven in the CW direction, and thereafter, the Y-axis drive mechanism 3 is stopped at a point when the Y-axis sensor 6 is turned off as shown in FIGS. 22A to 22C. At this time, since the Y-axis sensor 6 is in the OFF state, the Y-axis motor 31 of the Y-axis drive mechanism 3 is driven in the CCW direction and at a point when the Y-axis sensor 6 is turned to the ON state, the Y-axis drive mechanism 3 is stopped as shown in FIGS. 23A to 23C. As a result, the return to origin operations of the X-axis drive mechanism 2 and the Y-axis drive mechanism 3 are completed.

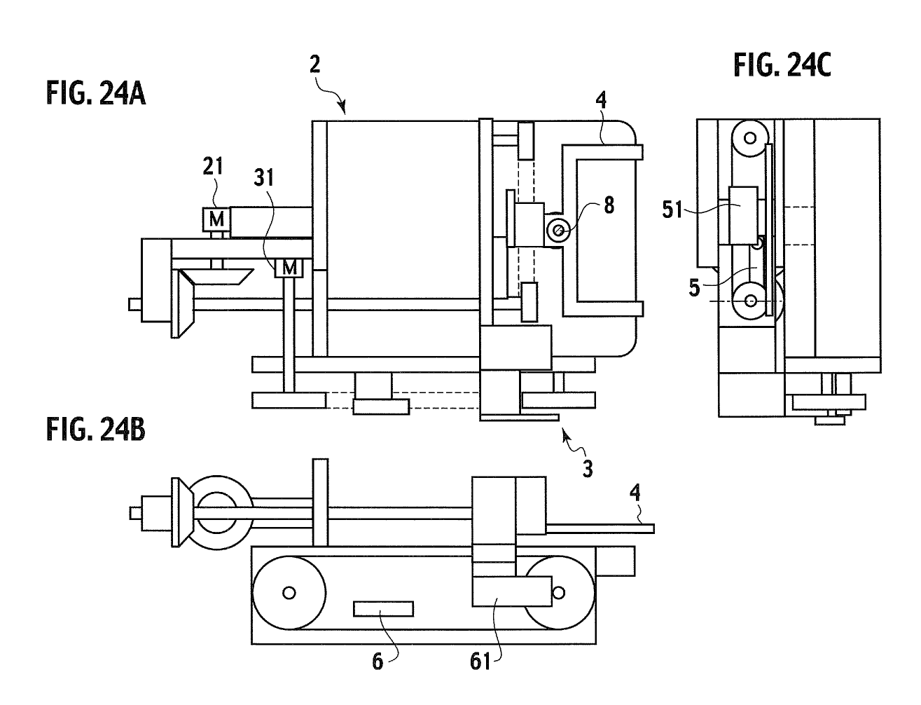

FIGS. 24A-24C to FIGS. 28A-28C show an example of the operations for computing the feed amount error and the position detection error with a position that the sensor is turned on is set as the origin. FIGS. 23A to 23C show a state in which the X-axis drive mechanism 2 and the Y-axis drive mechanism 3 are stopped with the X-axis sensor 5 and the Y-axis sensor 6 being in the ON state. From this state, the Y-axis drive mechanism 3 is operated in the CW direction as much as a certain amount so as to place the test target 8 within the image capturing range, and a reference image of the test target 8 is captured.

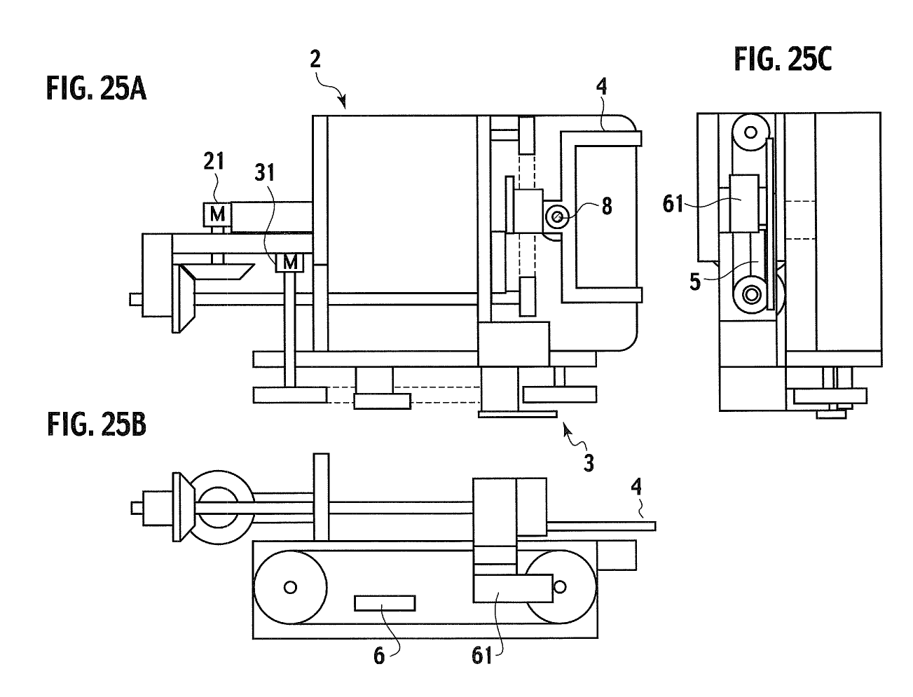

At this time, since the last rotation direction of the X-axis motor 21 of the X-axis drive mechanism 2 is CCW, lost motion is generated by driving the X-axis motor 21 in the CW direction. And in the course of operating the X-axis drive mechanism 2 until the X-axis sensor 5 is turned off from the ON state, the difference between the reference image and the captured image is monitored, and when a difference image having a dimension greater than or equal to a certain value is obtained, the count value α of the internal counter is taken in. Thereafter, as shown in FIGS. 25A to 25C, at a point when the X-axis sensor 5 is turned off, the count value γ of the internal counter is taken in, and the feed amount error with respect to the X-axis drive mechanism 2 and the position detection error with respect to the X-axis sensor 5 are computed from the two count values.

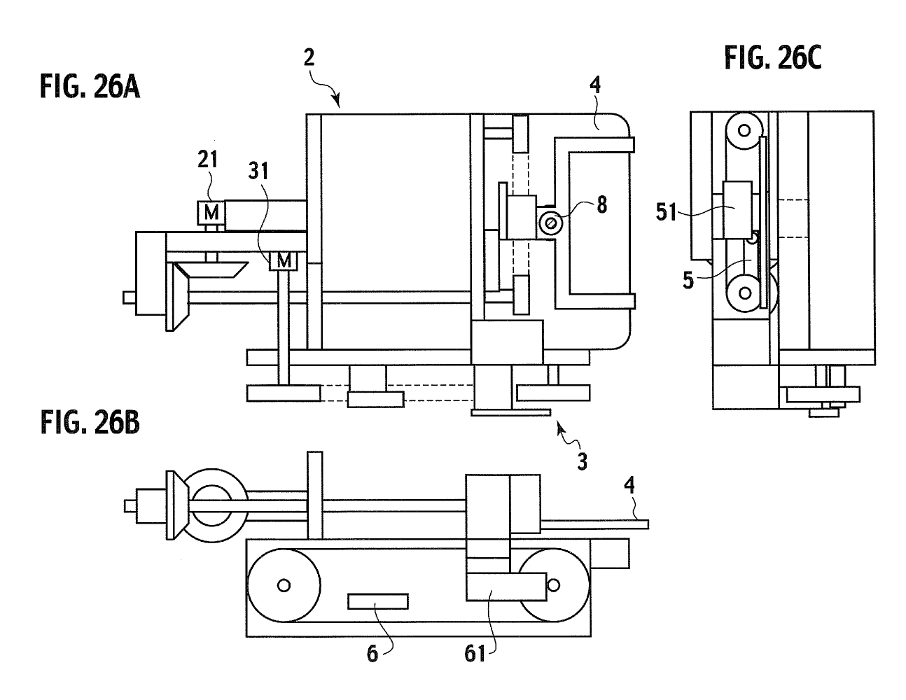

Next, as shown in FIGS. 26A to 26C, after the X-axis drive mechanism 2 is returned to the origin, computation of the feed amount error of the Y-axis drive mechanism 3 is started. At this time, since the last rotation direction of the Y-axis motor 31 is CW, lost motion is generated by driving the Y-axis motor 31 in the CCW direction. Then the difference between the reference image and the captured image is monitored, and when a difference image having a dimension greater than or equal to a certain value is obtained, the count value α of the internal counter is taken in, and the feed amount error with respect to the Y-axis drive mechanism 3 is computed.

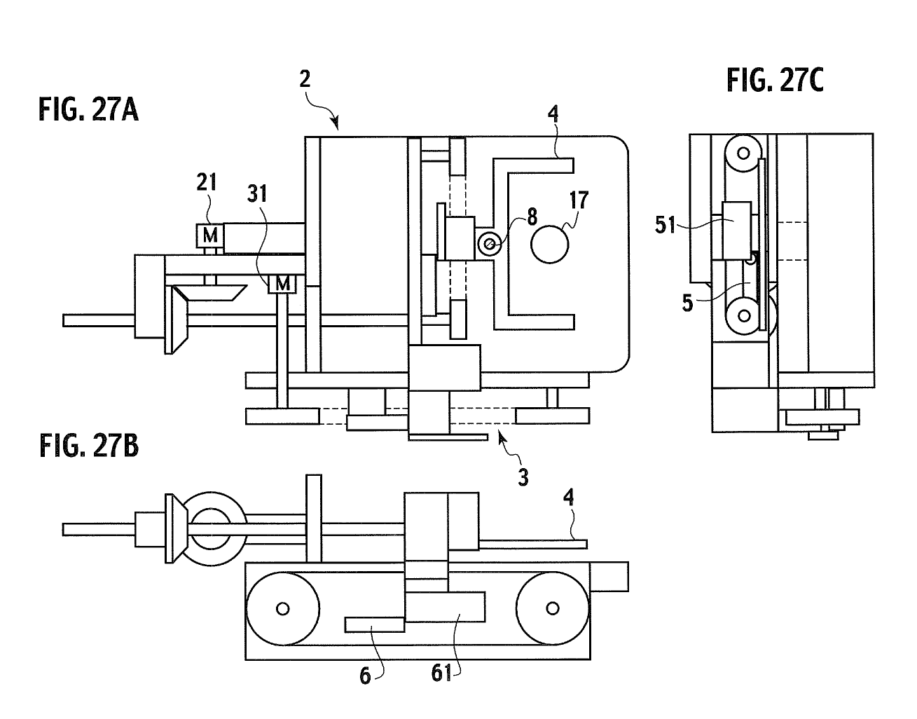

From the state that the feed amount error computation is completed with respect to the Y-axis as shown in FIGS. 27A to 27C, the Y-axis drive mechanism 3 further is returned to the origin, and thereafter the position detection error with respect to the Y-axis sensor 6 is computed. At this time, since the last rotation direction of the Y-axis motor 31 is CCW, lost motion is generated by driving the Y-axis motor 31 in the CW direction. Since the drive amount of the Y-axis motor 31 necessary for eliminating the lost motion already is computed, if the Y-axis motor 31 is rotated until the Y-axis sensor 6 is turned off, the position detection error with respect to the Y-axis sensor 6 also can be computed.

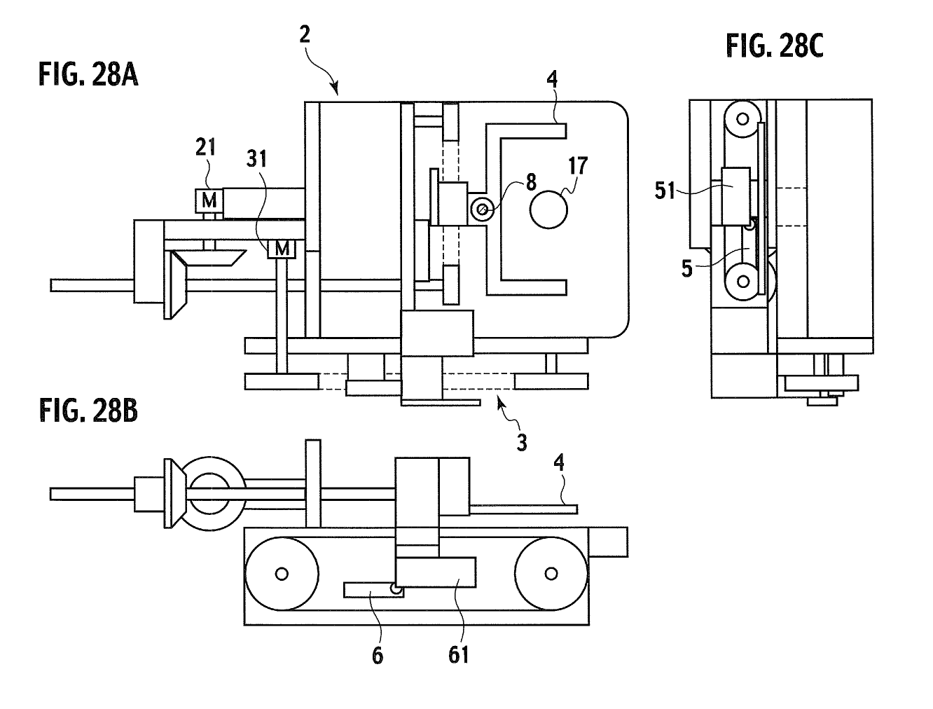

Lastly, as shown in FIGS. 28A to 28C, by returning the Y-axis drive mechanism 3 to the origin, the computation operations of the feed amount errors and the position detection errors with respect to the X-axis and the Y-axis are completed.

In addition, the X-axis drive mechanism 2 also may be returned to the origin at this time.

As such, after computing the feed amount errors (the numbers of drive pulses α) with respect to the X-axis drive mechanism and the Y-axis drive mechanism, and the position detection errors (the numbers of drive pulses β) with respect to the X-axis sensor and the Y-axis sensor, a proper positioning control of the observation device is performed by utilizing the computation results.

The feed amount errors with respect to the X-axis drive mechanism and the Y-axis drive mechanism are reflected in the positioning control as follows.

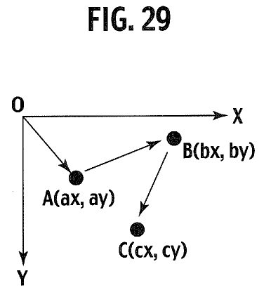

For example, as shown in FIG. 29, in a case that an observation object (cell) within the flask is observed at points A, B, and C starting from the origin O, when moving the observation position from point A(ax, ay) to point B(bx, by), the drive amount (the number of drive pulses) of the Y-axis motor is (ay−by+α_{y}) by taking into consideration the feed amount error α_{y} of the Y-axis drive mechanism.

Thereafter, when moving the observation position from point B(bx, by) to point C (cx, cy), the drive amount (the number of drive pulses) of the X-axis motor is (bx−cx+αₓ) by taking into consideration the feed amount error αₓ of the X-axis drive mechanism, and the drive amount (the number of drive pulses) of the Y-axis motor is (cy−by+α_{y}) by taking into consideration the feed amount error α_{y} of the Y-axis drive mechanism.

In addition, the X-axis sensor and the Y-axis sensor are associated with a gap (response difference) in the order of 10% of the detected distance between a switching position from the OFF state to the ON state upon approaching of the shield plate (a detected distance at the time of turning to the ON state) and a switching position from the ON state to the OFF state (a detected distance at the time of turning to the OFF state). The size of such gap varies depending on the temperature and the distance between the sensors and the shield plate. Because of this response difference, the position detection error is created.

In the observation device, when performing a cell observation with respect to a specific position of the cell cultured within an incubator, such a specific position is registered as coordinate information, and when manipulating on the cell, a moving operation is performed which moves the observation position to the registered coordinate position. However, while the incubation temperature within the incubator is maintained in 37° C., the cell manipulation for example is performed at room temperature, and thus, errors may occur in the return to origin operations using the X-axis sensor and the Y-axis sensor due to such temperature difference. As a result, the observation position may not be moved to the same position that is registered at the time of coordinate registration.

Thus, the position detection errors of the X-axis sensor 5 and the Y-axis sensor 6 are reflected in the positioning control as follows.

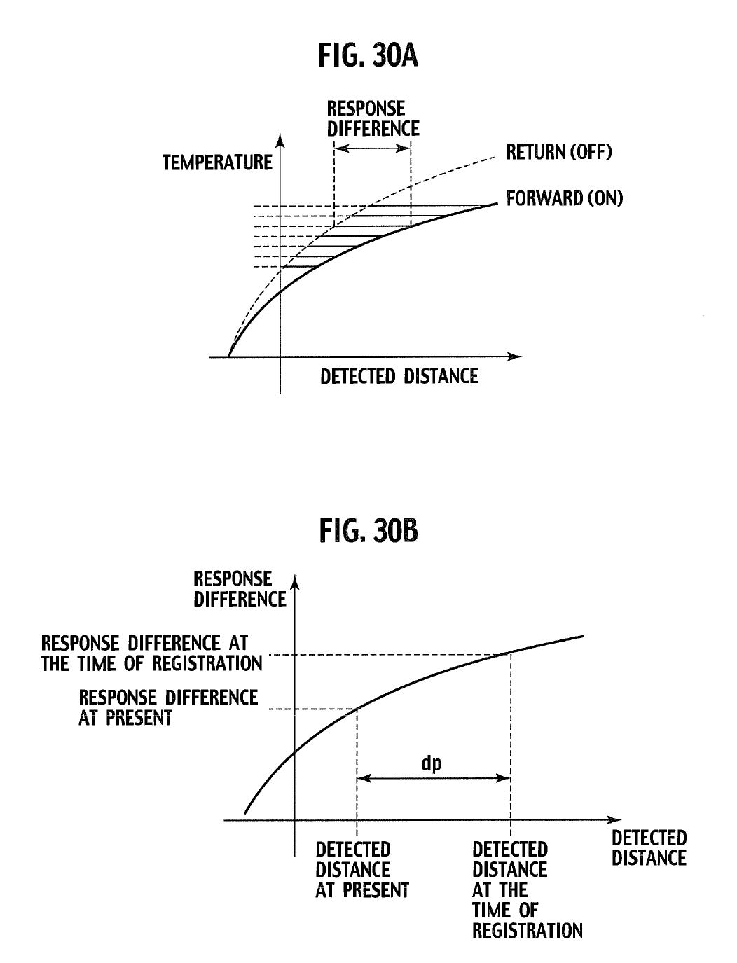

In the observation device according to the invention, a relationship between the temperature and the detected distance as shown in FIG. 30A and a relationship between the response difference and the detected distance as shown in 30B respectively are illustrated graphically or in a table format beforehand. Then, at the time of cell manipulation, the response difference under a present usage condition is computed from the relationship of FIG. 30A by obtaining the position detection error, and by applying that value in the relationship of FIG. 30B, the detected distance under the present usage environment is derived. Similarly, at the time of coordinate registration, the response difference is computed from the relationship of FIG. 30A and the position detection error, and the detected distance at the time of coordinate registration can be derived by applying that value in the relationship of FIG. 30B.

The difference between the detected distance under the present usage environment and the detected distance at the time of coordinate registration is set as dp, and by operating the coordinate difference dp to the registration coordinate value (i.e. adding in the illustrated example), the origin position that is the same as the origin position at the time of coordinate registration can be duplicated. Thus, it becomes possible to move the observation position at the time of cell manipulation to the same position as that at the time of coordinate registration.

As described above, according to the observation device of the present invention, it is possible to acquire each feed amount error of the X-axis drive mechanism and of the Y-axis drive mechanism, and each position detection error of the X-axis origin sensor and of the Y-axis origin sensor individually. As a result, in a positioning control with respect to the X-axis drive mechanism and the Y-axis drive mechanism, a control operation can be performed by taking into consideration the feed amount errors of both drive mechanisms 2 and 3 and the position detection errors of the both sensors 2 and 3. Thus, it becomes possible to prevent deterioration of positioning accuracy due to the change over time and change in environmental conditions.

In addition, highly accurate positioning can be achieved with an inexpensive mechanism system for the X-axis drive mechanism 2 and the Y-axis drive mechanism 3, without adopting an expensive ball screw mechanism that does not generate backlashes.

The present invention may be embodied in other specific forms without departing from the spirit or essential characteristics thereof. The embodiments are therefore to be considered in all respects as illustrative and not restrictive, the scope of the present invention being indicated by the appended claims rather than by the foregoing description, and all changes that come within the meaning and range of equivalency of the claims therefore are intended to be embraced therein.

For example, instead of the image pickup device 16 for capturing an image of the test target 8, various other optical detection means can be adopted which can accurately detect a point of time that the reciprocating body shifts from the resting state to the moving state without causing hysteresis, such as a displacement meter that captures a speckle pattern with a CCD camera by irradiating laser beam to the surface of the reciprocating body.

Also, the test target 8 may be formed by deposition or paint application on a glass plate if the optical system of the observation device is a transmission type. However, if the optical system of the observation device is an incident-light type, it can be formed in pattern printing such as in black and white that at least causes a different in contrast.

According to the conveyance control device, a control method of the conveyance device, and an observation device of the present invention, it is possible to acquire the feed amount error of the drive mechanism and the position detection error of the origin sensor individually, and as a result, in a positioning control of the reciprocating body, a control operation can be performed by individually taking into consideration the feed amount error and the position detection error.

What is claimed is:

1. A conveyance control device, comprising:
a reciprocating body that holds a conveyance object and reciprocates it on a predetermined conveyance path;
a drive mechanism that drives the reciprocating body along the conveyance path;
an origin sensor that is switched from a first output state to a second output state by the reciprocating body's reaching a predetermined position on the conveyance path;
a control circuit for controlling an operation of the drive mechanism;
a drive amount detection unit for detecting a drive amount of a power source of the drive mechanism; and
a movement detection unit for optically detecting a point of time that the reciprocating body shifts from a resting state to a moving state,
wherein the control circuit includes:
a movement control unit that moves the reciprocating body in one direction until the origin sensor is switched from the first output state to the second output state and then moves the reciprocating body in an opposite direction of the one direction until the origin sensor is switched from the second output state to the first output state in performing a positioning control of the reciprocating body; and
a drive amount acquisition unit that acquires, in the course of moving the reciprocating body by a control of the movement control unit, a first drive amount detected by the drive amount detection unit from a point of time that the origin sensor turns to the second output state and the reciprocating body starts moving in the opposite direction until a point of time that shifting of the reciprocating body from the resting state to the moving state is detected by the movement detection unit, and a second drive amount detected by the drive amount detection unit from the point of time that the shifting of the reciprocating body from the resting state to the moving state is detected by the movement detection unit until a point of time that the origin sensor turns to the first output state, and
wherein a control operation is performed taking into consideration the acquired first and second drive amounts in the positioning control of the reciprocating body.

2. The conveyance control device of claim 1, wherein the first drive amount is an amount of a feed amount error of the drive mechanism and the second drive amount is an amount of a position detection error of the origin sensor.

3. The conveyance control device of claim 1, wherein the origin sensor is provided on the conveyance path, and the origin sensor changes from the first output state to the second output state with approaching of a shield plate placed on the reciprocating body, and changes from the second output state to the first output state with leaving of the shield plate.

4. The conveyance control device of claim 1, wherein the movement detection unit comprises a test target provided on the reciprocating body and an image pickup device for capturing an image of the test target,
wherein in the course of moving the reciprocating body in the opposite direction from the second output state of the origin sensor to the first output state of the origin sensor, the image pickup device continuously captures images of the test pattern, and in which the movement detection unit determines that the reciprocating body has shifted from the resting state to the moving state when change occurs in the captured image.

5. A control program for a conveyance device comprising a reciprocating body that holds a conveyance object and reciprocates it on a predetermined conveyance path;
a drive mechanism that drives the reciprocating body along the conveyance path;
an origin sensor that is switched from a first output state to a second output state by the reciprocating body's reaching a predetermined position on the conveyance path;
a drive amount detection unit for detecting a drive amount of a power source of the drive mechanism; and
a movement detection unit for optically detecting a point of time that the reciprocating body shifts from a resting state to a moving state,
the control program causing a computer to execute:
a first process of moving the reciprocating body in one direction until the origin sensor is switched from the first output state to the second output state and resetting the drive amount detection unit at a point of time that the origin sensor turns to the second output state;
thereafter, in the course of moving the reciprocating body in an opposite direction of the one direction until the origin sensor is switched from the second output state to the first output state, a second process of monitoring an output signal of the movement detection unit and acquiring a first detection amount from the drive amount detection unit at a point of time that the reciprocating body shifts from the resting state to the moving state;
thereafter, a third process of acquiring a second detection amount from the drive amount detection unit at a point of time that the origin sensor turns to the first output state; and
a fourth process of deriving, from the first and second detection amounts, a feed amount error of the drive mechanism due to change of the movement direction of the reciprocating body, and a position detection error due to a response difference of the origin sensor between switching from the first output state to the second output state and switching from the second output state to the first output state,
wherein a positioning control of the reciprocating body is performed by taking into consideration the derived feed amount error and the derived position detection error.

6. An observation device, comprising:
a reciprocating body that holds a conveyance object and reciprocates it on a predetermined conveyance path; a drive mechanism that drives the reciprocating body along the conveyance path;
an image pickup device for capturing an image of an observation object held on the reciprocating body when the reciprocating body has reached a predetermined observation position on the conveyance path;
an origin sensor that is switched from a first output state to a second output state by the reciprocating body's reaching a predetermined position on the conveyance path;
a drive amount detection unit for detecting a drive amount of a power source of the drive mechanism; a movement detection unit for optically detecting a point of time that the reciprocating body shifts from a resting state to a moving state; and
a control circuit for controlling an operation of the drive mechanism, in which a test target whose image is captured by the observation device is provided on the reciprocating body,
wherein the movement detection unit determines that the reciprocating body has shifted from the resting state to the moving state at a point of time that change occurs in the image of the test target captured by the image pickup device, and
wherein the control circuit includes:
a movement control unit that moves the reciprocating body in one direction until the origin sensor is switched from the first output state to the second output state and then moves the reciprocating body in an opposite direction of the one direction until the origin sensor is switched from the second output state to the first output state in performing a positioning control of the reciprocating body; and
a drive amount acquisition unit that acquires a first drive amount detected by the drive amount detection unit from a point of time that the origin sensor turns to the second output state and the reciprocating body moves in the opposite direction until a point of time that the shifting of the reciprocating body from the resting state to the moving state is detected by the movement detection unit, and a second drive amount detected by the drive amount detection unit from the point of time that the shifting of the reciprocating body from the resting state to the moving state is detected by the movement detection unit until a point of time that the origin sensor turns to the first output state, in the course of moving the reciprocating body controlled by the movement control unit,
wherein a control operation is performed taking into consideration the acquired first drive amount and the acquired second drive amount in the positioning control of the reciprocating body.
